(19) United States
(12) Patent Application Publication
(10) Pub. No.: US 2015/0134382 A1
(43) Pub. Date: May 14, 2015

(54) INTERACTIVE VISUALIZATION OF WORKLOADS

(71) Applicant: Microsoft Corporation, Redmond, WA (US)

(72) Inventors: Morten Holm-Petersen, Gentofte (DK); Mirza Abdic', Jyllinge (DK); Maciej Krzysztof Zarzycki, Copenhagen (DK); Maciej Plaza, Kobenhavn (DK); Ievgenii Korovin, Charlottenlunc (DK)

(73) Assignee: Microsoft Corporation, Redmond, WA (US)

(21) Appl. No.: 14/078,863

(22) Filed: Nov. 13, 2013

(51) Int. Cl. G06Q 10/08; G06Q 10/06

(52) U.S. Cl. CPC G06Q 10/087; G06Q 10/0631
USPC 705/7.12

(57) ABSTRACT

Resource capacities and workloads are calculated and scaled for a set of resources, over time. Workloads that exceed capacities for the resources are identified and displayed against the scaled capacities for the resources, and suggested solutions that match workloads to capacities are generated.

### BACKGROUND

Many companies have resources that must be assigned or scheduled to perform various workloads. A manager who is in charge of those resources attempts to ensure that each of the resources is capable of performing the workloads that are scheduled for it on any given day. While the resources can take a wide variety of different forms, the present discussion will proceed with respect to the resources being warehouse resources. This discussion is provided for the sake of example only, and the discussion applies to other resources as well.

Employees who manage warehouses for physical products often need to make sure that each of the warehouses that they manage will be capable of processing the goods that are scheduled to arrive at, or ship from, those warehouses in the near future. The amount of goods to process may typically be identified by some type of business system. Business systems can take a wide variety of forms. For instance, they can include enterprise resource planning (ERP) systems, customer relations management (CRM) systems, line-of-business (LOB) systems, among others. The present discussion will proceed with respect to the business system being an ERP system, although this is exemplary only.

In an ERP system, a large number of purchase orders, transfer orders, sales orders and return orders can each list products that are to be received at, or shipped from, an organization on specific dates. The sums of goods on inbound and outbound orders for a given day indicates the workload for that day.

Warehouse managers are often in charge of managing a plurality of different warehouses. They normally need to understand how the orders for a specific day translate into a workload for the people manning the inbound and outbound docks in a warehouse. This problem is exacerbated by the fact that orders may be for different types of goods, some of them large and some of them small. For example, a thousand smaller items might be packed on a single pallet which can be moved quickly. On the other hand, fifty odd-shaped items might each be packed on separate pallets.

Thus, a warehouse manager normally attempts to translate the amount of inbound and outbound goods into a resulting number of handling units (such as pallets). The warehouse manager then compares the number of handling units to the number of units that the staff of the inbound or outbound docks, at the respective warehouses, can handle on the day when the workload is supposed to be accommodated.

To add to the complexity of this job, the capacity of any given dock may change from day to day. For instance, workers may be sick or on vacation, or they may be leaving early for various reasons. In addition, docks may be staffed differently on the weekends, in the evenings, over holidays or at other times. Further, some of the equipment used on a dock (such as a forklift or other material conveyance apparatus) may be out for maintenance at any given time.

Also, depending on the nature of the business conducted by the organization, it can be important to avoid overloading any given warehouse. For instance, if the organization handles groceries or other frozen (or otherwise perishable) products, then leaving incoming products outside on a loading dock until they can be processed may compromise the value of (and even spoil) those products. Further, even where the goods are not perishable, if they are shipped late to certain customers, because the warehouse is overloaded on a given day, this can result in a great deal of customer dissatisfaction.

In order to address these types of problems, current warehouse managers attempt to identify when more goods are planned to arrive at, or ship from, a given warehouse than that warehouse can handle on that day. When they are able to identify these problems ahead of time, they can attempt to handle the overload by taking a number of steps. They can ask some vendors to deliver portions of their deliveries on another date. They can request to ship to certain customers on an earlier date or on a later date. They can attempt to call in extra workers and equipment to handle the overload, or they can attempt to divert some of the traffic to a different warehouse. Moving part or all of the load to another date or warehouse normally means changing many transactional documents that dictate this type of movement.

The problem is further exacerbated by the nature of today's business. Warehouse managers often spend a great deal of time in meetings and traveling among the warehouses that they manage. This means that they are often attempting to conduct at least some of their business using mobile devices that do not have large computer monitors on which to view all of the complex information discussed above.

The discussion above is merely provided for general background information and is not intended to be used as an aid in determining the scope of the claimed subject matter.

### SUMMARY

Resource capacities and workloads are calculated and scaled for a set of resources, over time. Workloads that exceed capacities for the resources are identified and displayed against the scaled capacities for the resources.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative business system architecture.

FIG. 2 is a block diagram showing one embodiment of a warehouse management component in more detail.

FIGS. 3A and 3B (collectively FIG. 3) is a flow diagram illustrating one embodiment of the operation of the warehouse management component shown in FIG. 2 in projecting workload capacities and overloads.

FIG. 4 is one embodiment of a flow diagram showing the operation of the workload management component shown in FIG. 2 in simulating the movement of transactions based on user inputs.

FIGS. 5A-5F show various embodiments of user interface displays.

FIG. 6 shows one embodiment of the architecture shown in FIG. 1 deployed in a cloud computing architecture.

FIGS. 7-11 show various embodiments of mobile devices.

FIG. 12 is a block diagram of one illustrative computing environment.

### DETAILED DESCRIPTION

The present discussion deals with allowing a manager of various physical resources to view the workloads for those resources, as well as the capacities for those resources, over time. The discussion also proceeds with respect to the user being able to consider different actions to take and simulate changes to the workloads based on those actions. While the present discussion proceeds with respect to the resources being warehouses and workers, it will be appreciated that the particular resources can be a wide variety of other resources. For instance, if an organization has multiple different facilities that each have printing devices, then the workload for those printing devices (based on orders, etc.) can be viewed by the manager of those physical facilities, and changing the workload among the various facilities can be simulated and viewed as well. Other embodiments of physical resources are contemplated as well.

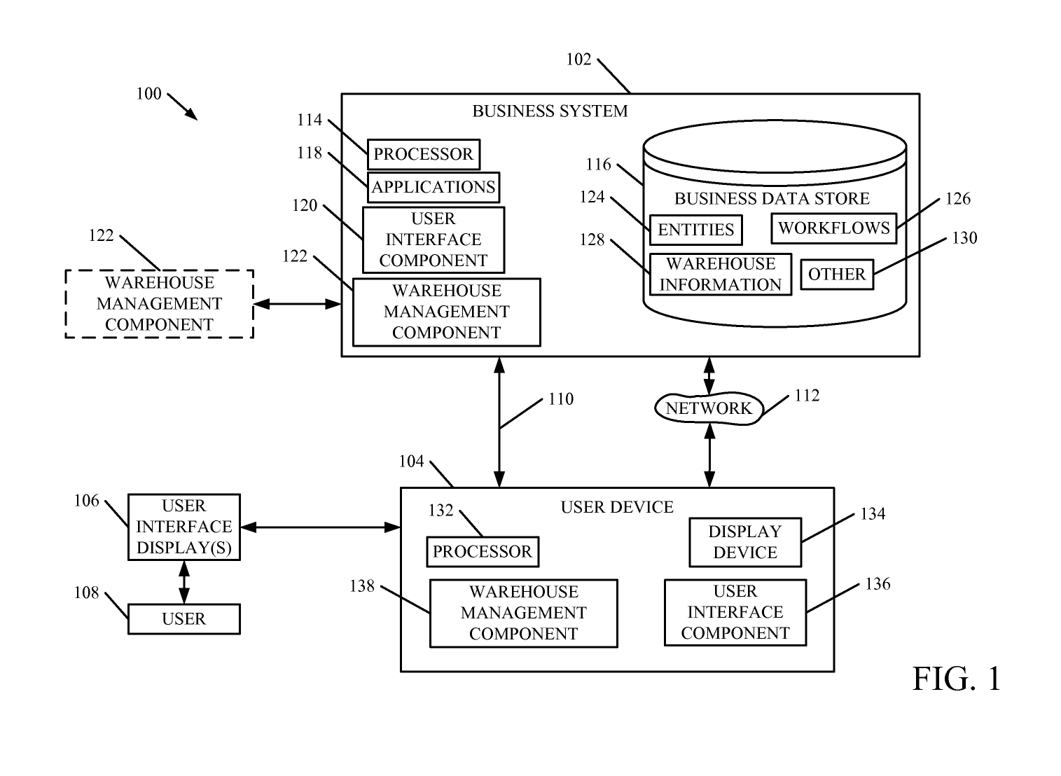

FIG. 1 is a block diagram of one illustrative business system architecture 100. Business system architecture 100 illustratively includes business system 102 and user device 104. User device 104 illustratively generates user interface displays 106 that have user input mechanisms that can be interacted with by user 108 in order to control and manipulate user device 104 and business system 102. FIG. 1 shows that user device 104 can access business system 102 either directly (as indicated by arrow 110) or over a network 112. Network 112 can be a wide area network, a local area network, or another type of network.

FIG. 1 shows that, in one embodiment, business system 102 illustratively includes processor 114, business data store 116, applications 118, user interface component 120 and warehouse management component 122. FIG. 1 shows an alternative embodiment in which warehouse management component 122 (shown in phantom) is separate from business system 102, and accessed by business system 102. However, for the sake of the present discussion, warehouse management component 122 will be discussed as being a part of business system 102, although this is exemplary only.

Business data store 116 illustratively stores business data that can be accessed by applications 118 in order to perform activities, tasks, operations, etc. that help users to conduct the business of the organization that deploys business system 102. The data can illustratively include entities 124, workflows 126, warehouse information 128, and other information 130. Entities 124 illustratively represent items related to the business of the organization deploying business system 102. For instance, a customer entity represents a customer. A vendor entity represents a vendor. A warehouse entity represents a warehouse. A product entity represents one or more products.

Entities 124 can also include information that can be used to calculate the workload assigned to various warehouses at various times. For instance, purchase order entities represent purchase orders and can include a number of items corresponding to a given purchase order, that are to pass through a warehouse loading dock on a given day. Transfer order entities represent transfer orders that identify a number of items to be transferred by the organization. Sales order entities represent sales orders that can also identify a number of items sold by the organization. Return order entities illustratively represent return orders that are being returned to the organization. Each of these types of entities illustratively lists products that are to be received at, or shipped from, the organization on specific dates. These are exemplary only and a wide variety of different entities can be used as well.

Warehouse information 128 illustratively includes information regarding the identity of various warehouses used by the organization, and the capacity of those warehouses, on a day to day basis. It can also include other information, such as whether temporary workers can be easily employed and, if so, how many. It can include information such as what capacity any given warehouse has on both its incoming and outgoing loading docks, on various days, and other information.

Applications 118 illustratively include business applications that are run in order to assist users in conducting the business of the organization. They can, for instance, include general ledger applications, business opportunity tracking applications, inventory applications, among others. The applications illustratively access data store 116 and operate on the data and workflows in data store 116.

User interface component 120 illustratively generates user interface displays (either by itself or under the control of other items in business system 102) that can be displayed to user 108. The user interface displays can be user interface displays 106, or other user interface displays. They can include user input mechanisms that can be used by user 108 to manipulate and control system 102.

Warehouse management component 122 illustratively accesses the warehouse information 128 and other information in business data store 116. It generates user interface displays 106 that allow user 108 (such as a warehouse manager) to view the various workloads that are projected for that warehouse manager's warehouses, over time, based upon the various sales orders, purchase orders, transfer orders, return orders, etc., stored by business system 102. The operation of warehouse management component 122 is described in greater detail below.

FIG. 1 also shows that user device 104 illustratively includes processor 132, display device 134, user interface component 136 and client warehouse management component 138. In one embodiment, both processors 114 and 132 are computer processors with associated memory and timing circuitry, not separately shown. They are functional parts of business system 102 and user device 104, respectively. They are illustratively activated by the other items, devices or components on business system 102 and user device 104, respectively, and facilitate the functionality thereof.

Display device 134 illustratively displays the user interface displays 106 for interaction by user 108. In one embodiment, the display device is a relatively small device (such as when user device 104 is a cellular telephone, a smart phone, a tablet computer, a hand held computer, or another type of mobile device). It can be a touch sensitive display device so that user input mechanisms displayed thereon can be actuated by the user using touch gestures (such as with the user's finger, a stylus, etc.).

User interface component 136 (like user interface component 120) illustratively generates user interface displays either by itself, or under control of other devices, processors or components, for display to user 108. While two user interface components (120 and 136) are shown in FIG. 1, it will be noted that fewer user interface components can be used, and they can be located either in business system 102 or on device 104. Of course, additional user interface components can be used as well.

Client warehouse management component 138 is illustratively a client application that allows user 108 to interact with warehouse management component 122 on business system 102. It will be appreciated, however, that in another embodiment only a single management component 122 (or 138) is used. It can be located either on business system 102, or on device 104, or separately (as shown by the dashed box in FIG. 1) and accessed by either business system 102 or user device 104, or both. In the embodiment discussed herein, client warehouse management component 138 provides the functionality that allows user 108 to access, and interact with, warehouse management component 122 on business system 102. However, this particular configuration is described for the sake of example only.

User interface displays 106 illustratively include input mechanisms that can take a wide variety of different forms. The user input mechanisms can be, for instance, text boxes, check boxes, buttons, links, icons, tiles, dropdown menus or other user actuatable input mechanisms. In addition, they can be actuated in a wide variety of different ways. They can be actuated using a point and click device (such as a mouse or track ball) or using other hardware items, such as a thumb pad, thumb switch, a keypad, or other buttons or hardware mechanisms. Further, where display device 134 is a touch sensitive screen, they can be actuated with touch gestures using the user's finger or stylus. Also, where user device 104 includes speech recognition components, the user input mechanisms can illustratively be actuated using speech commands. In any case, user 108 illustratively interacts with the user input mechanisms on user interface displays 106 in order to access warehouse management component 122 to view warehouse capacities, and workloads, and in order to simulate transfer of various orders to different dates, to different facilities, or to simulate adding employees on various different dates, among other things. A number of these exemplary scenarios are described in greater detail below.

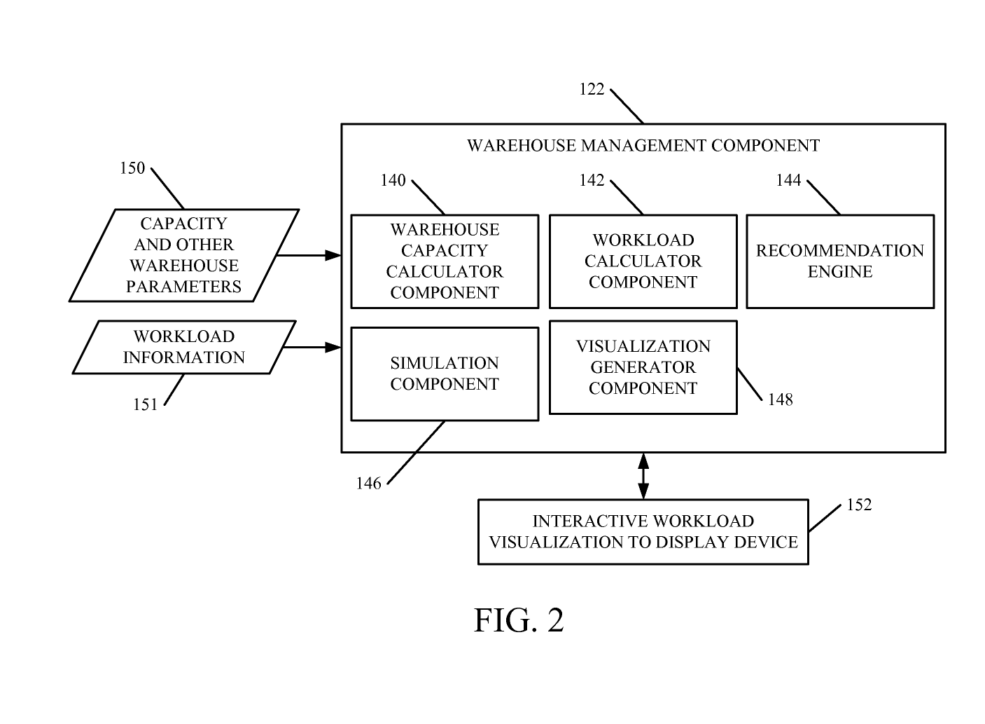

FIG. 2 is a flow diagram illustrating one embodiment of a block diagram of warehouse management component 122 in greater detail. FIG. 2 shows that warehouse management component 122 illustratively includes warehouse capacity calculator component 140, workload calculator component 142, recommendation engine 144, simulation component 146 and visualization generator component 148. FIG. 2 shows that warehouse management component 122 has access to various capacity and other warehouse parameters 150 and generates an interactive workload visualization 152 that can be displayed using display device 134 of user device 104. Capacity and other warehouse parameters 150 illustratively allow warehouse capacity calculator component 140 to calculate the capacity of a given warehouse on a given day. Therefore, the parameters may include the number of employees employed at the given warehouse, the number of employees that are on vacation or on sick leave, the equipment that is currently available at the warehouse, etc. The particular way that capacity is calculated may vary based on the particular application.

Workload information 151 illustratively allows workload calculator component 142 to calculate the workload corresponding to each of the warehouses. Therefore, it illustratively includes sales orders, purchase orders, return orders, transfer orders, and other such information that identifies a number of items that are to be received at, or shipped from, the given warehouse on a given day. When a user identifies that a warehouse is going to be over its capacity on a given day, the user can illustratively use recommendation engine 144 to identify different recommendations, such as moving a transaction to a different day, or to a different warehouse, or both. The recommendations can also be a suggestion to increase the number of employees at a given warehouse on a given day, or other suggestions as well.

Simulation component 146 illustratively allows the user to simulate the effect of taking one of the recommendations. For instance, the user can simulate moving one transaction to a different day, at the same warehouse. The user can also simulate moving multiple transactions to multiple different warehouses on multiple different days, or other workload changes. Simulation component 146 allows the user to simulate these types of changes in workload.

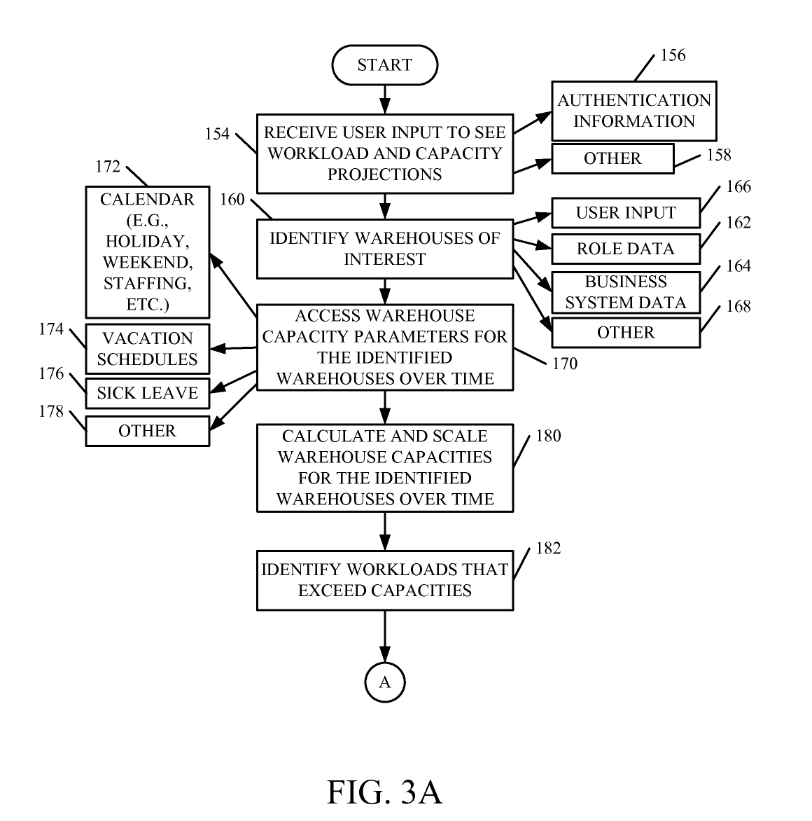

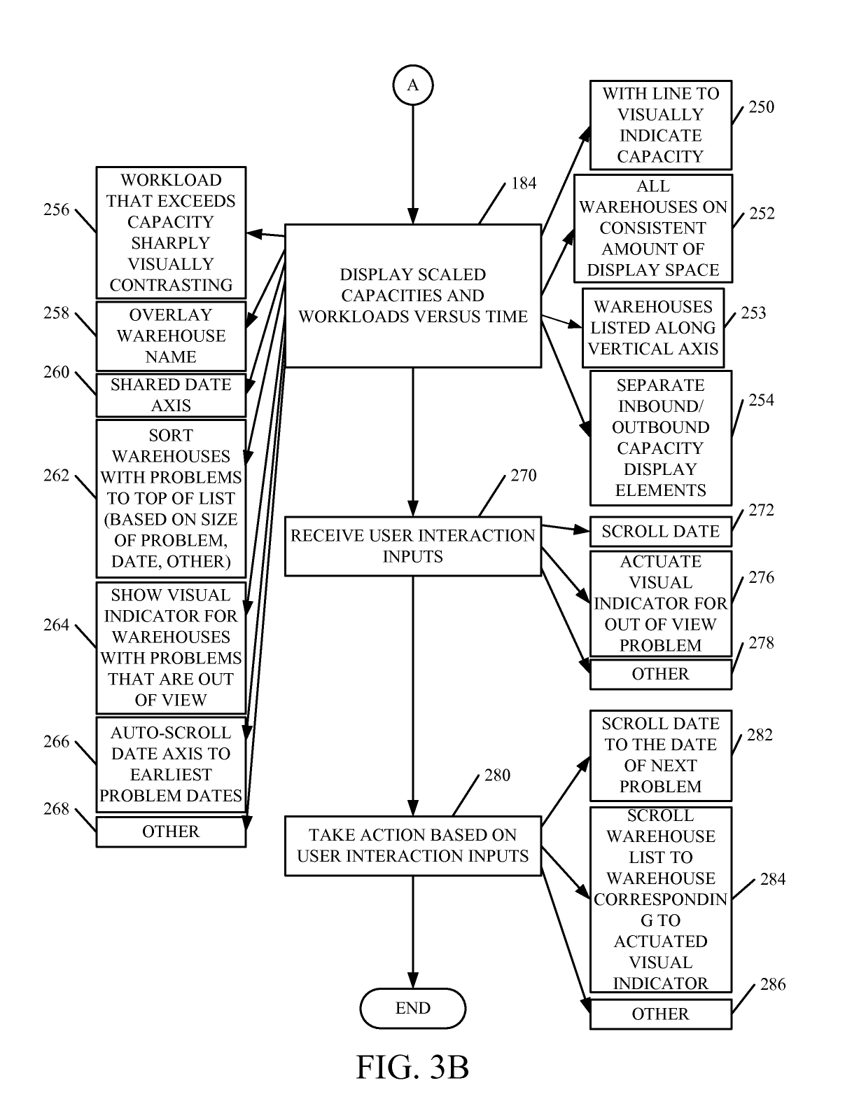

FIGS. 3A and 3B are collectively referred to as FIG. 3 and show a flow diagram illustrating one embodiment of the operation of warehouse management component 122 (shown in FIG. 2) in generating the interactive workload visualization 152 that shows the various workloads and capacities for a number of different warehouses, plotted against time.

Warehouse management component 122 first receives user inputs indicating that the user wishes to see the workload and capacity projections for various warehouses. This is indicated by block 154 in FIG. 3. The user inputs can include a wide variety of different information. For instance, they can include authentication information 156 that identifies the particular user as a warehouse manager for a plurality of different warehouses. The authentication information can include a username and password or other information that identifies user 108. Warehouse management component 122 can then access business data store 116 to identify the particular warehouses that user 108 has access to. The user inputs can include other information as well, and this is indicated by block 158 in FIG. 3.

Warehouse management component 122 then identifies the particular warehouses of interest. This is indicated by block 160 in FIG. 3. For instance, as discussed above, warehouse management component 122 can identify the particular warehouses that the user 108 manages. This can be done using role data 162. For instance, where the user is a warehouse manager for a given region, the user may have access to information about a first set of warehouses, and those are identified as the warehouses of interest. However, where the user is a sales manager or another employee, the user may have access to information about other warehouses, and those other warehouses are identified as the warehouses of interest. Thus, other business system data 164 can be used to identify the warehouses of interest for this particular user.

In another embodiment, user 108 simply selects from a list of available warehouses using a suitable user input mechanism. This is indicated by block 166 in FIG. 3. Of course, the warehouses of interest can be identified by warehouse management component 122 in other ways as well, and this is indicated by block 168 in FIG. 3.

Warehouse capacity calculator component 140 then accesses the capacity and other warehouse parameters 150 for the identified warehouses. This is indicated by block 170 in FIG. 3. As briefly discussed above, capacity and other warehouse parameters 150 can include calendar information 172, such as whether the dates for which the capacity is being calculated fall on a holiday, a weekend, or other times where staffing issues occur. It can include vacation schedules 174 that indicate when employees of the warehouses of interest are on vacation. It can include sick leave information 176 that indicates when various employees are on sick leave. It can include a whole host of other information as well, and this is indicated by block 178.

Warehouse capacity calculator component 140 then calculates and scales the warehouse capacities for the identified warehouses, over time. This is indicated by block 180.

The information is scaled because different warehouses may have very different capacities on different days. As is described in greater detail below with respect to block 184, warehouse capacity calculator component 140 generates an index value that indexes the actual capacity of a given warehouse on a given day. Full capacity for each warehouse (regardless of its actual gross capacity) corresponds to the same index value. For instance, full capacity for every warehouse can be scaled to an index value of 100. This equalizes the capacities for a display so that the user can easily judge the percentage of available capacity (or overload) of a given warehouse on a given day, with a quick look at the display of the scaled values.

Workload calculator component 142 calculates the workload, relative to the index, for each day, for each warehouse. Workload calculator component 142 then identifies workloads that exceed the capacities of their corresponding warehouses on individual days. This is indicated by block 182 in FIG. 3.

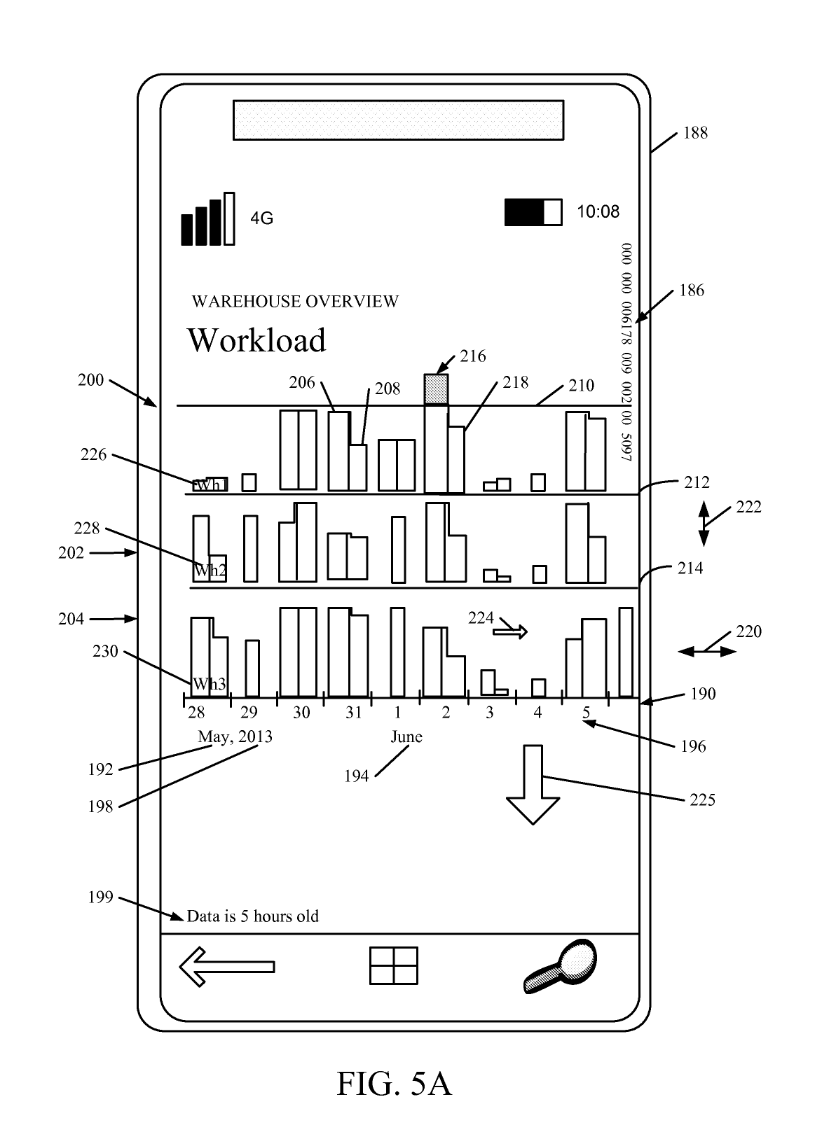

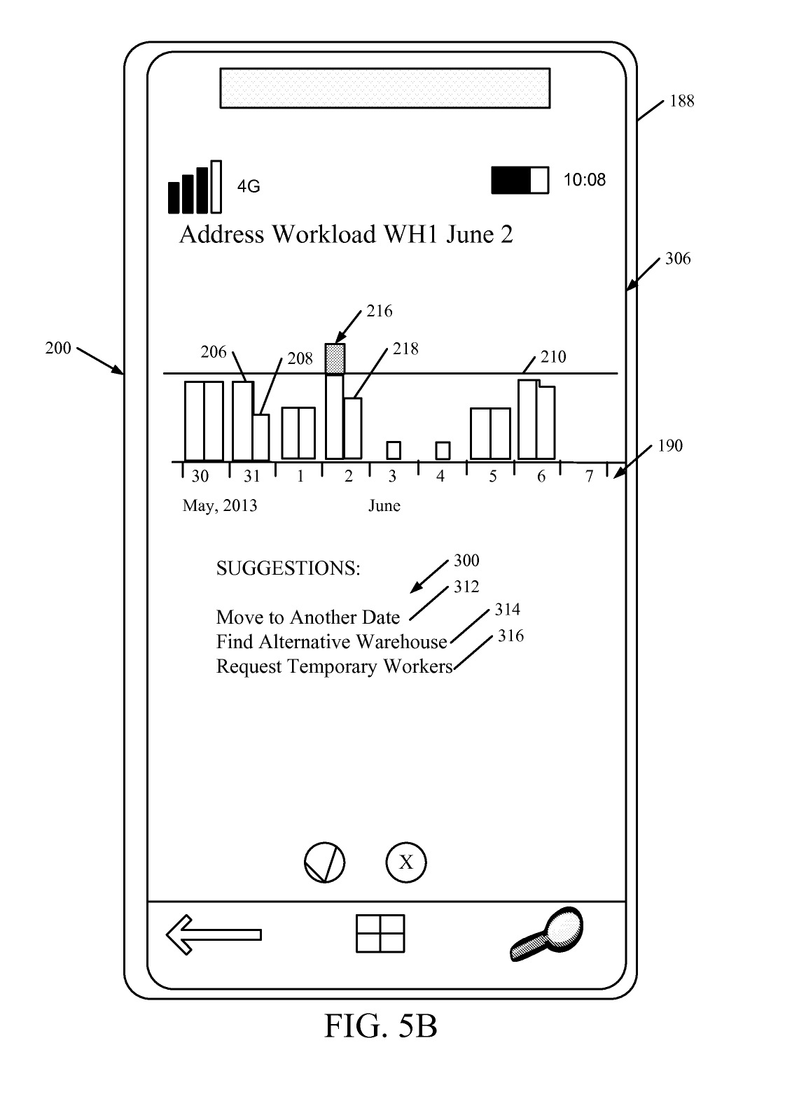

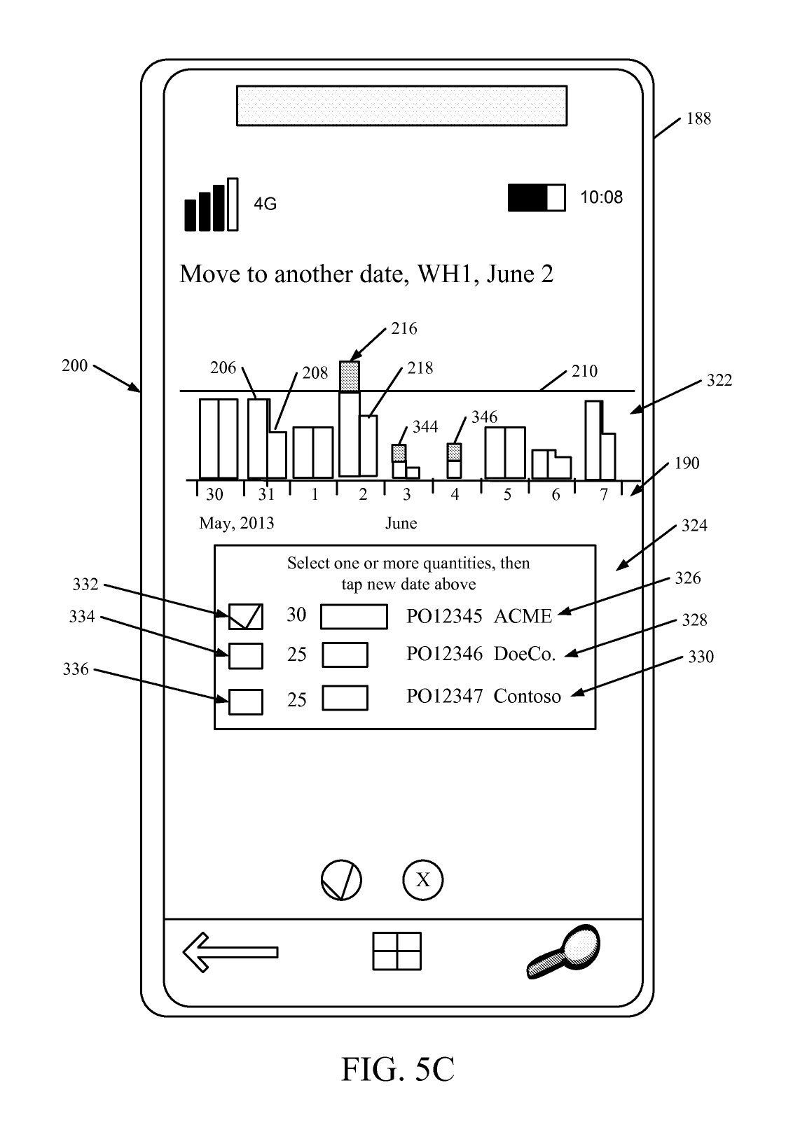

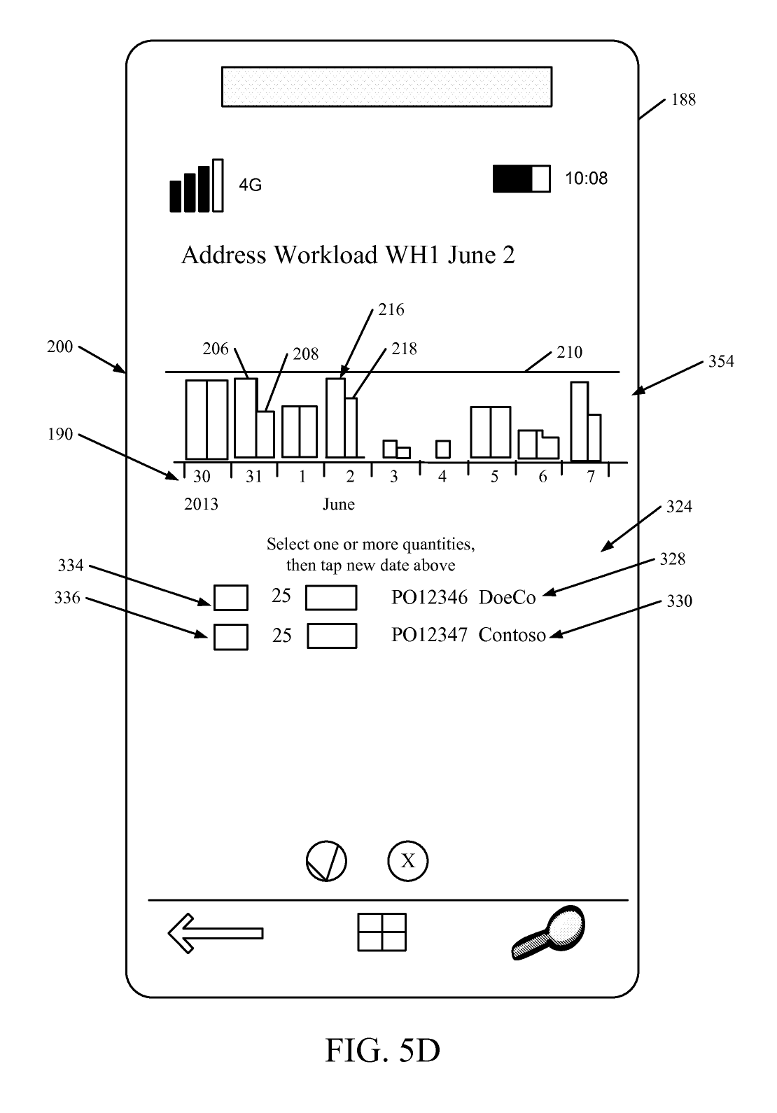

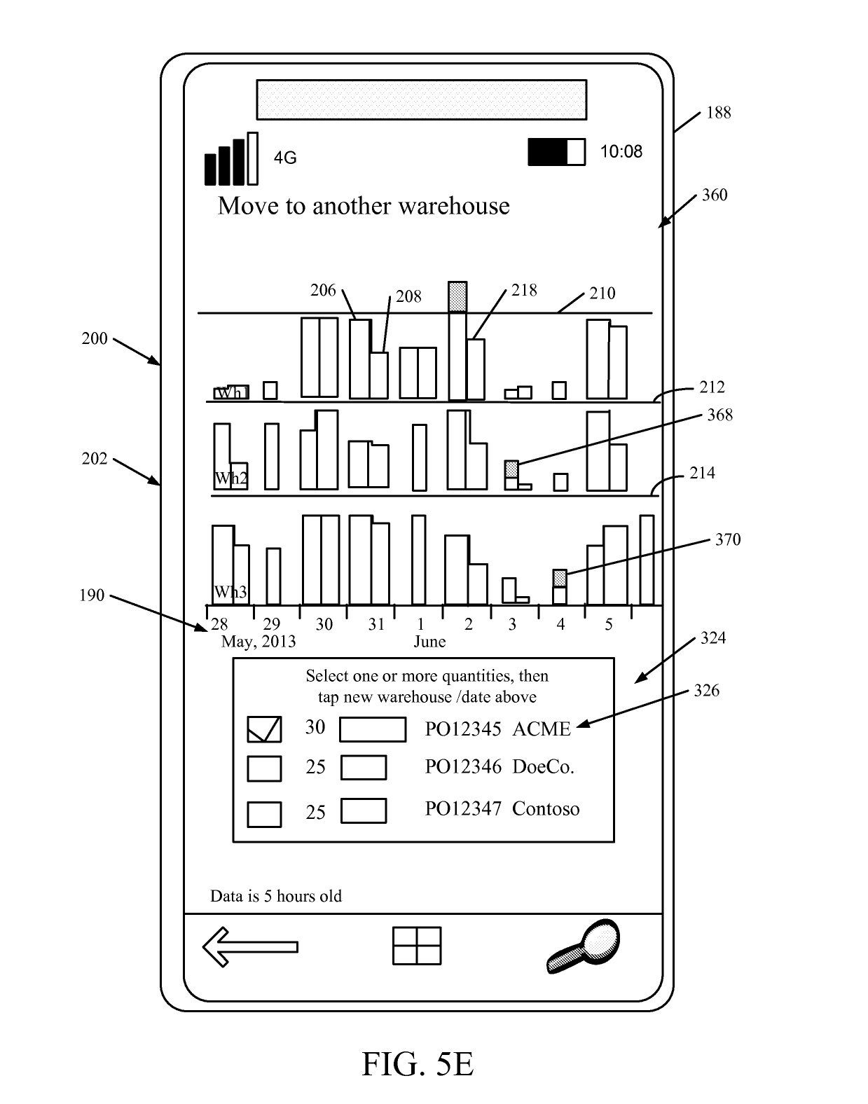

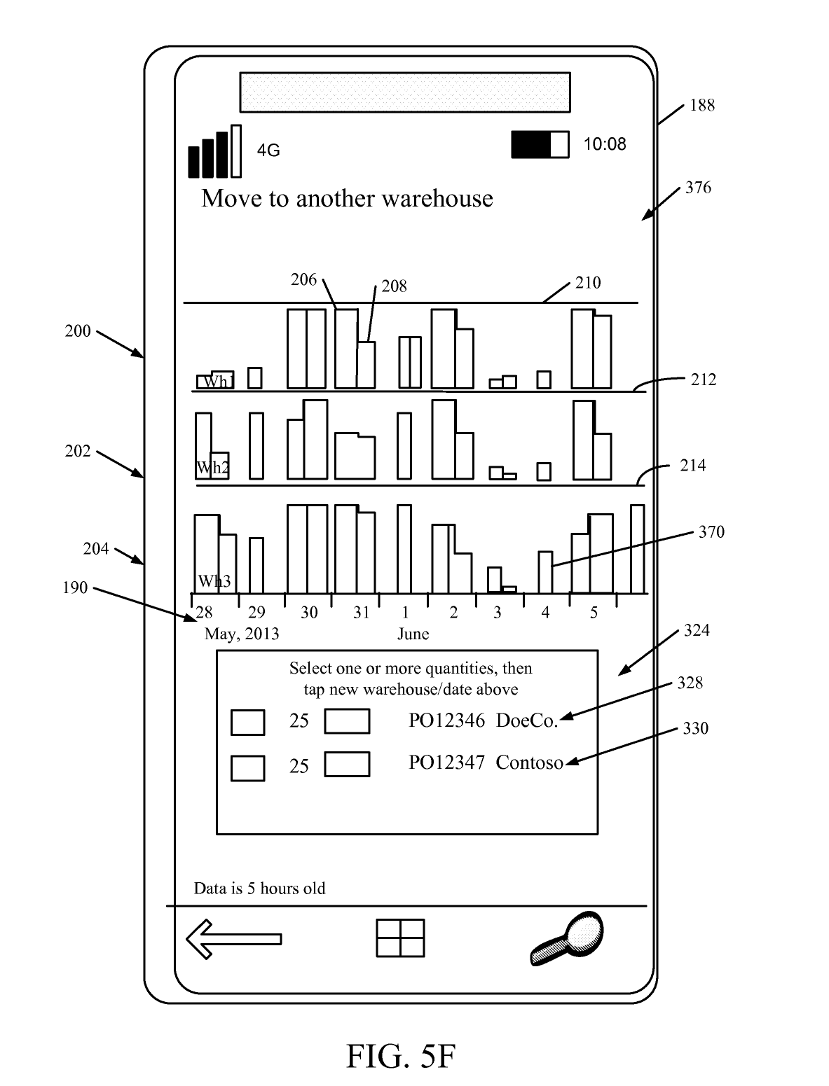

Visualization generator component 148 then displays the scaled capacities and scaled workloads, of each warehouse, versus time. This is indicated by block 184 in FIG. 3. FIG. 5A shows one embodiment of a user interface display 186 on mobile device 188, that illustrates this. Display 186 includes a date display shown generally at 190. Date display 190 includes month indicators 192 and 194 that correspond to the day indicators shown generally at 196. A year indicator 198 qualifies the entire date display 190.

In the example shown in FIG. 5A, it can be seen that the date display 190 shows warehouse capacity and workload information for the days May 28-31, 2013 and Jun. 1-5, 2013. Display 186 also includes workload and capacity displays for three separate warehouses. The information for warehouse 1 is shown generally at 200. The information for warehouse 2 is shown generally at 202 and the information for warehouse 3 is shown generally at 204. The warehouse information displayed on each day may include two separate bar graphs. One bar graph corresponds to the inbound loading dock while the other bar graph corresponds to the outbound loading dock at the specified warehouse. However, it can also be configured to show one common bar graph.

By way of example, it can be seen that on May 31^{st}, the display 200 for warehouse 1 includes an inbound bar graph 206 and an outbound bar graph 208. Bar graphs 206 and 208 show the projected workload for the inbound and outbound loading docks, respectively, for warehouse 1, on May 31, 2013. Each warehouse display 200, 202 and 204 also illustratively includes a maximum capacity visual indicator. In the embodiment shown in FIG. 5, the maximum capacity visual indicator for warehouse 1 is line 210. For warehouse 2, it is line 212, and for warehouse 3, it is line 214. Thus, when one of the bar graphs on a given date reach that line, that means that the workload for the inbound or outbound loading dock, for that warehouse, is at its capacity. Where the bar graph surpasses the line, it indicates that the workload exceeds the capacity of that warehouse, and where the bar graph is below the line, it indicates that the workload for that warehouse does not meet its capacity. For instance, it can be seen that bar 206 for warehouse 1 touches capacity line 210. Thus, the workload for the inbound loading dock in warehouse 1 meets its capacity, on May 31, 2013. However, because bar 208 does not reach line 210, that means that the workload on the outbound dock of warehouse 1 on May 31, 2013, has not yet reached its capacity, and more workload could be added to that date, before the capacity is met.

As another example, it can be seen that, on Jun. 2, 2013, the workload for the inbound loading dock in warehouse 1 is displayed by bar 216. The bar passes the visual indicator line 210 that shows the capacity for the inbound loading dock, and therefore the workload indicated by bar 216 exceeds the capacity of warehouse 1 on Jun. 2, 2013. The amount by which bar 216 exceeds the capacity line 210 is illustratively displayed in a markedly visually contrasting way indicated by the portion 218 of bar 216 that lies above line 210. This enables user 108 to quickly identify problem areas (that is, areas where a workload for a warehouse exceeds its capacity on a given day). The marked visual contrast can be shown in a variety of different ways, including color, shading, blinking or in many other ways.

FIG. 5A also shows a number of other features. For instance, a plurality of different warehouses all have a workload capacity display that share a single date display 190. Thus, the workload and capacity displays for the various warehouses can be scrolled horizontally, as generally indicated by arrow 220. In that case, the date display 190 is scrolled as well, to follow the warehouse displays. The month display (May and June) illustratively stay on the display as long as any of the days (indicated at 196) lie in that month. For instance, as the display is scrolled to the left in FIG. 5A, the word “May” will stay on the display as long as any of the days 28, 29, 30 or 31 are displayed. After that, the word “May” will scroll off the display to the left, and the year display 198 will be displayed on the right hand side of the June display 194. Having only a single date display 190, with a single day line 196 that is qualified by only one month indicator per month displayed (either indicator 192 or 194 or both), all of which is qualified by a single year indicator 198 saves display space. This can be helpful on devices with relatively small displays, such as smart phones, cell phones, tablet computers, etc.

The list of warehouses displayed in FIG. 5A is also illustratively scrollable in the vertical direction, as generally indicated by arrow 222. For instance, if the user wishes to view information for more than three warehouses, the user can scroll the warehouse information vertically in the upward direction to view information for additional warehouses, and that information is displayed along the same date axis 190.

Display 186 also illustratively includes a visual indicator 224 that corresponds to warehouses that have problems that are not displayed in the current view. For instance, visual indicator 224 is illustratively an arrow (and it can be displayed in a contrasting color, such as red or another color) in close proximity to the information displayed for warehouse 3. This indicates that warehouse 3 has a workload which exceeds its capacity at some date in the future, which is off of the display currently being shown. In one embodiment, when the user actuates arrow 224 (such as by tapping it or otherwise), the display is automatically scrolled to the date where warehouse 3 has a problem (e.g., where its workload exceeds its capacity).

Also, in one embodiment, display 186 includes visual indicator 225, which can be similar to visual indicator 224, except that it indicates that there is a warehouse with a problem that is not currently displayed. Where the user actuates indicator 224, the display is automatically scrolled vertically (and horizontally) to display information for the problematic warehouse.

The display shown in FIG. 5A also shows that the warehouse label indicators 226, 228 and 230 are overlaid over the actual warehouse information being displayed. This again saves space on the display, yet still enables a user to easily view the warehouse workload and capacity data for the different warehouses.

Further, the display shown in FIG. 5A includes a data freshness indicator shown generally at 199. This allows the user to quickly determine whether the data should be refreshed.

In one embodiment, when the user first wishes to view the workload and capacity information, visualization generator component 148 generates the display 186 and automatically scrolls it to the first date where the is a problem with any of the warehouses being displayed (that is, where a workload exceeds the capacity of a warehouse). It also can illustratively sort the warehouses in the list of warehouses so that those with the most urgent problems are displayed first, based on various metrics that the business desires to use. In one embodiment, for instance, the warehouse with the largest excess workload (over capacity) is displayed first, but this is exemplary only. By way of example, if a workload for a given warehouse is double its capacity on a given day, visualization generator component 148 sorts the display information for that warehouse to the top of the list displayed to user 108. Thus, user 108 will be alerted to this problem immediately.

Referring again to the flow diagram of FIG. 3, displaying the scaled capacities and workloads with the line visually indicating the capacity for a warehouse is indicated by block 250. Showing all warehouses on a consistent amount of display space on the user interface display 186 is indicated by block 252. This is accomplished by indexing the capacity of each warehouse so that it appears the same, regardless of the day on which it is being displayed. Displaying a list of warehouses that can be scrolled along a vertical axis is indicated by block 253, and separating the inbound and outbound capacity is indicated by block 254. Displaying a workload that exceeds the capacity of a given warehouse in a sharply visually contrasting way is indicated by block 256. Overlaying the warehouse name on its corresponding information is indicated by block 258. Having multiple warehouse displays sharing the same date axis is indicated by block 260. Sorting the warehouse displays that have problems to the top of the list (based on the size of the problem, the date of the problem, or otherwise) is indicated by block 262. Showing a visual indicator for warehouses with problems that are out of view is indicated by block 264, and automatically scrolling the display along the date axis to an earliest problem date is indicated by block 266. Of course, displaying the workload and capacity versus time can be done in other ways as well, and this is indicated by block 268.

Once the workload and capacity information is displayed as shown in FIG. 5A, user 108 can illustratively interact with the displayed information. Receiving user interaction inputs is indicated by block 270 in FIG. 3. For instance, as mentioned above, the user can scroll the display horizontally along date axis 190. This is indicated by block 272. The user can actuate the visual indicator 224 for out of view problems, as indicated by block 276. Of course, the user can perform other operations (such as scrolling the list of warehouses vertically, or providing other inputs) and this indicated by block 278.

In response, visualization generator component 148 illustratively takes action based on the user interaction inputs. This is indicated by block 280. For instance, where the user scrolls the date axis 190, component 148 can illustratively scroll to the date of the next problem. This is indicated by block 282. Where the user actuates the visual indicator 225, component 148 can scroll the warehouse list to the warehouse corresponding to the actuated visual indicator. This is indicated by block 284. Of course, the user can perform a wide variety of other interactions to change the information being viewed, and this is indicated by block 286.

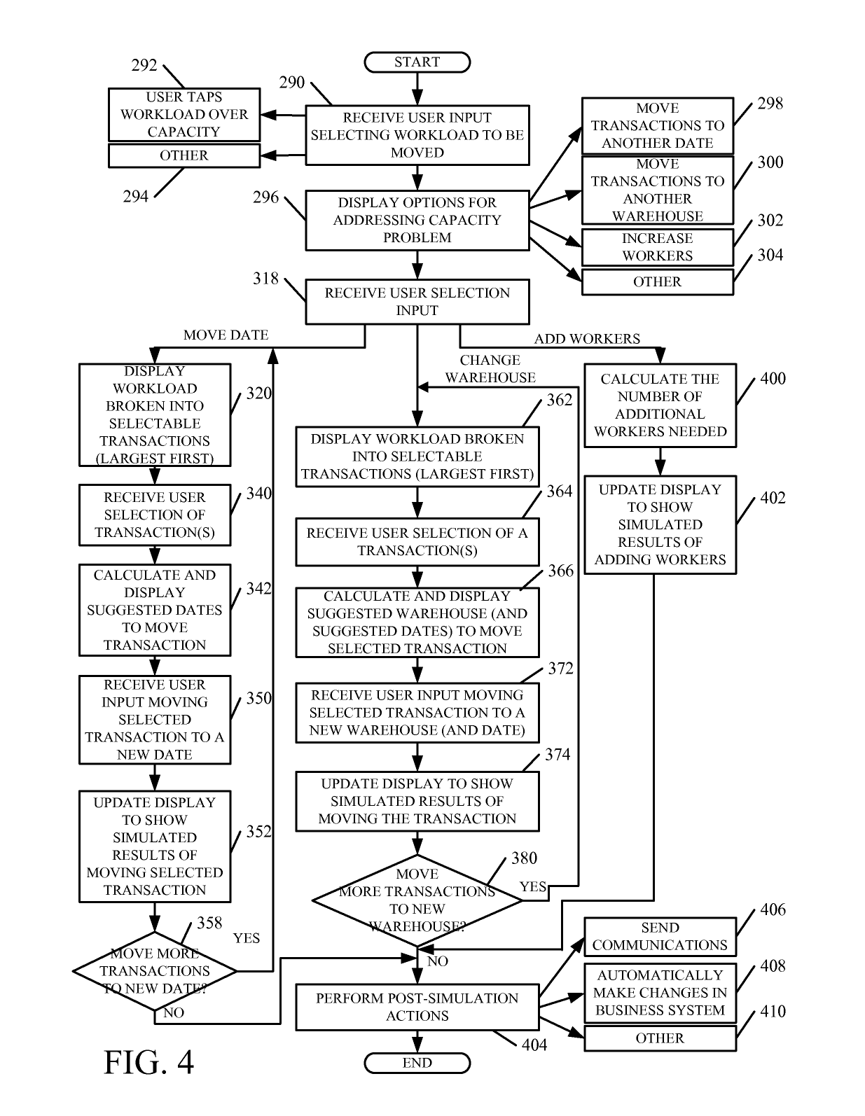

The user 108 can also illustratively interact with display 186 in order to simulate moving workloads among various warehouses or to different dates. FIG. 4 is a flow diagram illustrating one embodiment of the operation of warehouse management component 122 in doing various examples of this. By way of example, and continuing with the display shown in FIG. 5A, assume that user 108 wishes to transfer part of the workload 218 on June 2^{nd} for warehouse 1 so that the workload for that warehouse does not exceed its capacity on that day. User 108 illustratively provides a user input indicating this. This can be done by selecting a portion of warehouse's workload that is to be moved. Receiving the user input selecting a workload to be moved is indicated by block 290 in FIG. 4. The user can do this in a wide variety of different ways. In one embodiment, the user simply taps the portion of the workload 218 that is visually highlighted, and that exceeds the workload capacity for warehouse 1. Tapping the workload over capacity is indicated by block 292 in FIG. 4. Identifying the workload to be moved can be done in other ways, and this is indicated by block 294.

In response, recommendation engine 144 illustratively calculates and displays options for addressing the capacity problem. This is indicated by block 296. For instance, the recommendation engine 144 can provide recommendations or suggestions to move one or more transactions to another date. This is indicated by block 298. It can suggest moving one or more transactions to another warehouse, as indicated by block 300. It can also suggest increasing the workers at warehouse 1 on June 2^{nd}. This is indicated by block 302. It can provide other suggestions as well, and this is indicated by block 304. Recommendation engine 144 can calculate the most suitable options.

To calculate which automatic action (move to another date, warehouse, etc.) is the most suitable, for each suggestion, a cost F can be calculated as a number. This can be done in many different ways. Eq. 1 below shows one exemplary way.

F=w1*c1+w2*c2+ . . . +wn*cn Eq. 1

where each cn represents a cost of a specified parameter (like the number of days the workload needs to be moved by, workload pressure on the target day/warehouse, cost of the physical movement if another warehouse is chosen, etc). Each wn parameter is an empirically adjusted weight associated with the given cost in the overall number.

So an exemplary formula might be:

$$F = w 1 * ( number of days to move by ) ; + \\ w 2 * ( cost of physical movement ) ; + \\ w 3 * ( \begin{matrix}1 if target day \text{/} warehouse results in \\ workload > 95 \% of capacity\end{matrix} ) ; and + \\ w 4 * ( 1 if gold customer ) \text{//} don \text{'} t change orders for important customers$$

Then after calculating F for a number of choices, the choices are sorted (with lower cost choices first) and presented to the user.

FIG. 5B shows one embodiment of a user interface display 306 that can be generated on mobile device 188 in response to the user tapping the workload portion 218 that exceeds the capacity of warehouse 1 on June 2^{nd}. Some of the items shown in FIG. 5B are similar to those shown in FIG. 5A, and are similarly numbered. User interface display 306 generally displays the same warehouse information for warehouse 1 (at 200) that is shown in FIG. 5A. It also displays a suggestion portion (of suggestions) 310. Suggestion portion 310 illustratively includes a plurality of different suggestions displayed using user actuable input mechanisms. For instance, suggestions 310 include “move to another date” displayed on user input mechanism 312. Suggestions 310 also include “find alternative warehouse” displayed on user input mechanism 314 and “request temporary workers” displayed on user input mechanism 316.

Each of user input mechanisms 312-316 can illustratively be actuated by user 108, by the user simply tapping or touching them, or otherwise actuating them. Thus, if the user wishes to simulate moving workload 218 to another date, the user illustratively actuates mechanism 312. If the user wishes to simulate moving workload 218 to a different warehouse, the user illustratively actuates mechanism 316, and if the user wishes to simulate requesting temporary workers, the user illustratively actuates mechanism 316. Receiving user selection of one of the suggestions is indicated by block 318 in the flow diagram of FIG. 4.

When the user actuates the “move to another date” user input mechanism 312, visualization generator component 148 illustratively displays the excess workload 218 broken into selectable transactions, with the largest transaction first. This is indicated by block 320 in FIG. 4. FIG. 5C shows an embodiment of a user interface display 322 displayed on mobile device 188 in response to the user indicating that the user wishes to move the date of the excess workload 218. A number of items are similar to those shown in FIG. 5B, and they are similarly numbered.

However, it can be seen that display 322 includes a transaction breakdown display 324. Transaction breakdown display 324 illustratively breaks the workload of not only excessive workload 218, but the entire workload for the inbound loading dock (represented by bar 216) into the transactions that make up that workload. It can be seen in FIG. 5C, for instance, that the transactions include a purchase order number “12345” for the Acme company which makes up an index value of 30 units. This transaction is shown generally at 326. The workload also illustratively includes that associated with purchase order number “12346”, for DoeCo. which corresponds to 25 index units, and this is shown at 328. The final transaction making up workload 216 is a purchase order “12347” for Contoso as indicated generally at 330. Each of the transactions illustratively has a selection mechanism, such as a check boxes 332, 334 and 336. The user can select one or more of the transactions in section 324, by checking check boxes 332-336. Receiving user selection of one or more of the transactions is indicated by block 340 in the flow diagram of FIG. 4.

Once the user has selected one or more of the transactions shown generally at 324, recommendation engine 144 illustratively calculates and displays suggested dates to which the user 108 can move the transaction in warehouse 1, in order to accommodate that workload, without exceeding the capacity of warehouse 1. This is indicated by block 342 in the flow diagram of FIG. 4, and the dates can be calculated using Equation 1 above or in other ways. The display 322 of FIG. 5C includes two highlighted suggestions 344 and 346. It can be seen that, if the index units corresponding to transaction 326 are moved to June 3^{th} or to June 4^{th}, warehouse 1 can handle that transaction without exceeding the capacity of the warehouse on that date. Thus, recommendation engine 144 visually displays indicators 344 and 346 as suggestions for moving transaction 326.

It will be appreciated that recommendation engine 144 can calculate the recommendations in a variety of different ways. This is described in greater detail below. Suffice it to say, for now, that recommendation engine 144 has found two different dates on which warehouse 1 can handle transaction 326, on its inbound loading dock, without exceeding the capacity for the warehouse on that date. It displays visual indicators 344 and 346 so that user 108 can easily identify these as recommended dates.

Visualization generator component 148 then receives a user input moving the selected transaction to the new date. This is indicated by block 350 in the flow diagram of FIG. 4. In one embodiment, the user can simply tap either visual indicator 344 or 346 to indicate that the user wishes to move transaction 326 to that date. Of course, the user can use a drag and drop input or another suitable user input as well.

Simulation component 146 then calculates a simulated workload and capacity display indicating what the workload and capacity for warehouse 1 will look like, if transaction 326 is actually moved to the suggested date selected by the user. Visualization generator component 148 then generates a visualization of the simulated results of the move. Updating the display to show the simulated results of moving the selected transaction is indicated by block 352 in the flow diagram of FIG. 4.

FIG. 5D is one illustrative user interface display 354, on mobile device 188, that shows this. Display 354 shows some similar things to those shown in display 322 in FIG. 5C, and similar items are similarly numbered. However, a number of things have been updated. First, it can be seen that the transaction 326 (in FIG. 5C) has been moved from June 2^{nd} to June 3^{rd}. Therefore, the bar 356 corresponding to the workload for the inbound loading dock of warehouse 1 has increased by 30 index units (because that is the number of index units represented by transaction 326). The user can now easily see that the capacity for warehouse 1 is no longer being exceeded by its workload on June 2^{nd}. Thus, the user can see that moving one transaction by one day will alleviate the excess capacity issue for warehouse 1.

FIG. 5D also shows that the transaction display section 324 now only includes two transactions (328 and 330) for June 2^{nd}. In the present example, since the workload on June 2^{nd} no longer exceeds capacity, the user may not wish to move any more transactions. However, in another example, it may be that even after moving the largest transaction on a given day, the workload for a warehouse still exceeds its capacity. In that case, the user can simply repeat the process of moving a transaction to a different day, as discussed above. This is indicated by block 358 in the flow diagram of FIG. 4.

Referring again to FIG. 5B, if, instead of choosing to move a transaction to another date, the user actuates mechanism 314 to find an alternative warehouse for the excess workload, visualization generator component 148 illustratively generates a user interface display, such as display 360 shown in FIG. 5E. Some of the items shown in FIG. 5E are similar to those shown in FIG. 5A and they are similarly numbered. However, it can be seen that user interface display 360 displays the workload for the selected date (June 2^{nd} of warehouse 1) broken down by its selectable transactions, as discussed above with respect to FIG. 5C. Instead of only showing the warehouse data for warehouse 1, display 360 continues to show the warehouse data for all of the warehouses in the list of warehouses. Displaying the workload for warehouse 1 broken into its selectable transactions (with the largest being first) is indicated by block 362 in the flow diagram of FIG. 4.

Again, as described above with respect to FIG. 5C, user 108 can select one or more of the transactions to be moved to a different warehouse, on the same or different date. Receiving user selection of one or more of the transactions is indicated by block 364 in FIG. 4. As with FIG. 5C, FIG. 5E shows that the user has selected the first transaction 326 which corresponds to 30 index units. Recommendation engine 144 then calculates and displays one or more suggested warehouses, and one or more suggested dates, for moving the selected transaction. This is indicated by block 366 in FIG. 4. In the example shown in FIG. 5E, recommendation engine 144 has recommended June 3^{rd} for warehouse 2 (as indicated by visual indicator 368) or June 4^{th} for warehouse 3 (as indicated by visual indicator 370).

Visual generator component 148 then receives a user input moving the selected transaction to a new warehouse (and possibly a new date as well). This is indicate by block 372 in FIG. 4. In one embodiment, the user simply taps on one of the suggestions corresponding to visual indicators 368 and 370. In another embodiment, the user can use a drag and drop input to drag either visual indicator 218 or the transaction 326, to one of visual indicators 368 and 370, to indicate that the user wishes to move the transaction to that warehouse, on that specific date.

Simulation component 146 then calculates a new workload and capacity display based on the simulated move of the selected transaction (transaction 326) to one of the other warehouses and dates. Visualization generator component 148 then updates the interactive visualization to show the results of moving the selected transaction as indicated by the user. This is indicated by block 374 in the flow diagram of FIG. 4. FIG. 5F shows a user interface display 376 that indicates this.

It can be seen that a number of the items in FIG. 5F are similar to those shown in FIG. 5E, and they are similarly numbered. However, it can now be seen that a bar 376 corresponding to the inbound workload of warehouse 3 on Jun. 4, 2013 has been updated to add the index units for transaction 326. Thus, the user can quickly see the simulated results of actually transferring transaction 326 from warehouse 1, on June 2^{nd}, to warehouse 3, on June 4^{th}. User 108 can quickly see that this move not only brings the workload on June 2^{nd} at warehouse 1 within its capacity, but also brings the workload in warehouse 3, on June 4^{th}, closer to its capacity.

Display 376 also shows that transaction display section 324 has been modified to indicate that only two more transactions remain for the inbound loading dock on June 2^{nd}, at warehouse 1. Again, the user can move more transactions if desired. This is indicated by block 380 in the flow diagram of FIG. 4.

Referring again to FIG. 5B, it will be noted that the user can also request to simply add temporary workers by actuating mechanism 316. If the user does this, recommendation engine 144 illustratively accesses the warehouse data indicative of how many workers are available, and how many index units can be served by each worker. Engine 144 then calculates a number of additional workers needed. This is indicated by block 400 in FIG. 4. Simulation component 146 then takes this information and calculates a new simulated workload and capacity for warehouse 1 to indicate whether the added workers will increase the capacity of warehouse 1 sufficiently that the workload can be handled. Visualization generator component 148 then updates the interactive display to indicate this. This is indicated by block 402 in FIG. 4.

After the user has simulated different ways of addressing the excess capacity for warehouse 1, warehouse management component 122 can illustratively perform post-simulation actions. This is indicated by block 404 in FIG. 4. By way of example, where the user wishes to change a transaction from one date to another, or from one warehouse to another, or where the user wishes to add workers, it may be that various communications are to be generated. For instance, it may be that the user needs to generate electronic mail messages, telephone messages, or other messages to different people so that the documentation and personnel can be changed, as desired. Sending communications is indicated by block 406 in FIG. 4. It may also be that warehouse management component 122 is authorized to automatically make changes within business system 102 to update shipping and delivery dates, or other information. Automatically making those changes is indicated by block 408. The post-simulation actions can take a wide variety of other forms as well, and this is indicated by block 410.

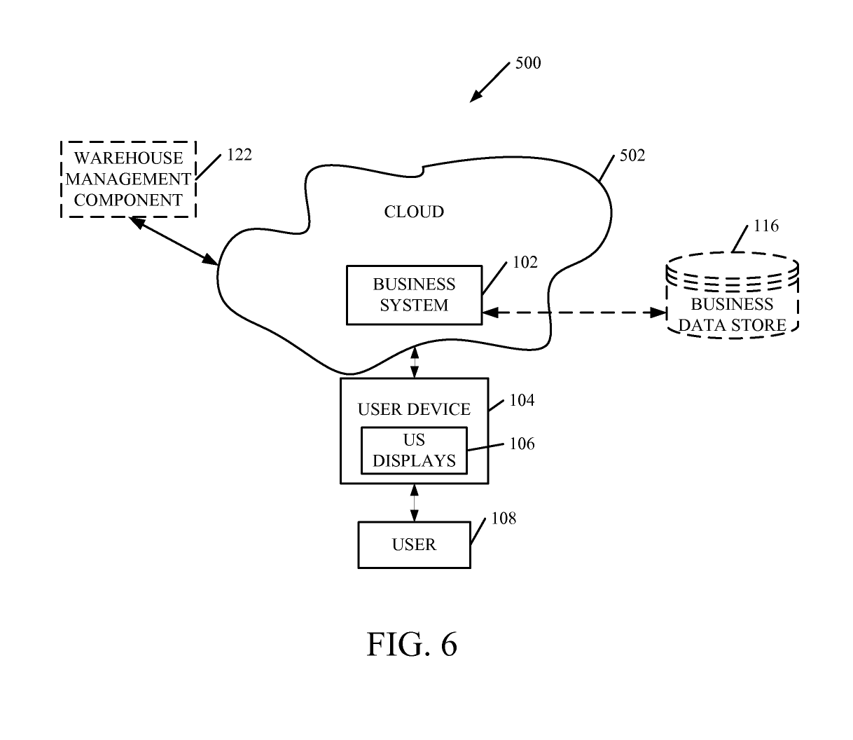

FIG. 6 is a block diagram of architecture 100, shown in FIG. 1, except that its elements are disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of architecture 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 6, some items are similar to those shown in FIG. 1 and they are similarly numbered. FIG. 6 specifically shows that business system 102 is located in cloud 502 (which can be public, private, or a combination where portions are public while others are private). Therefore, user 108 uses a user device 104 to access system 102 through cloud 502.

FIG. 6 also depicts another embodiment of a cloud architecture. FIG. 6 shows that it is also contemplated that some elements of system 102 are disposed in cloud 502 while others are not. By way of example, data store 116 can be disposed outside of cloud 502, and accessed through cloud 502. In another embodiment, warehouse management component 122 is also outside of cloud 502. Regardless of where they are located, they can be accessed directly by device 104, through a network (either a wide area network or a local area network), they can be hosted at a remote site by a service, or they can be provided as a service through a cloud or accessed by a connection service that resides in the cloud. All of these architectures are contemplated herein.

It will also be noted that architecture 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

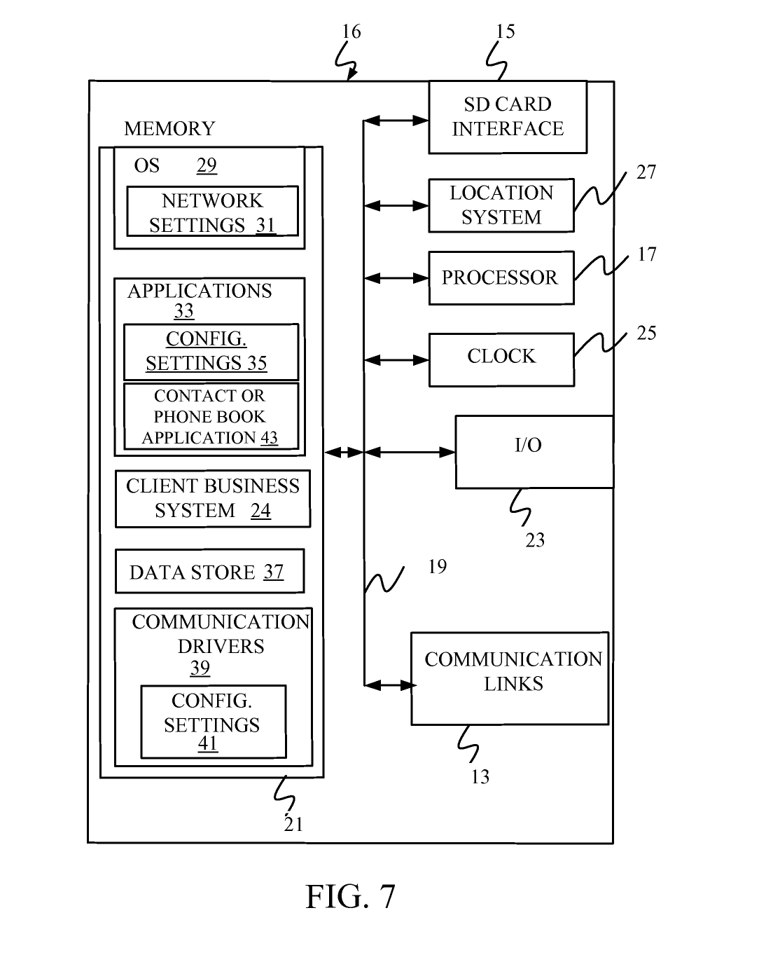

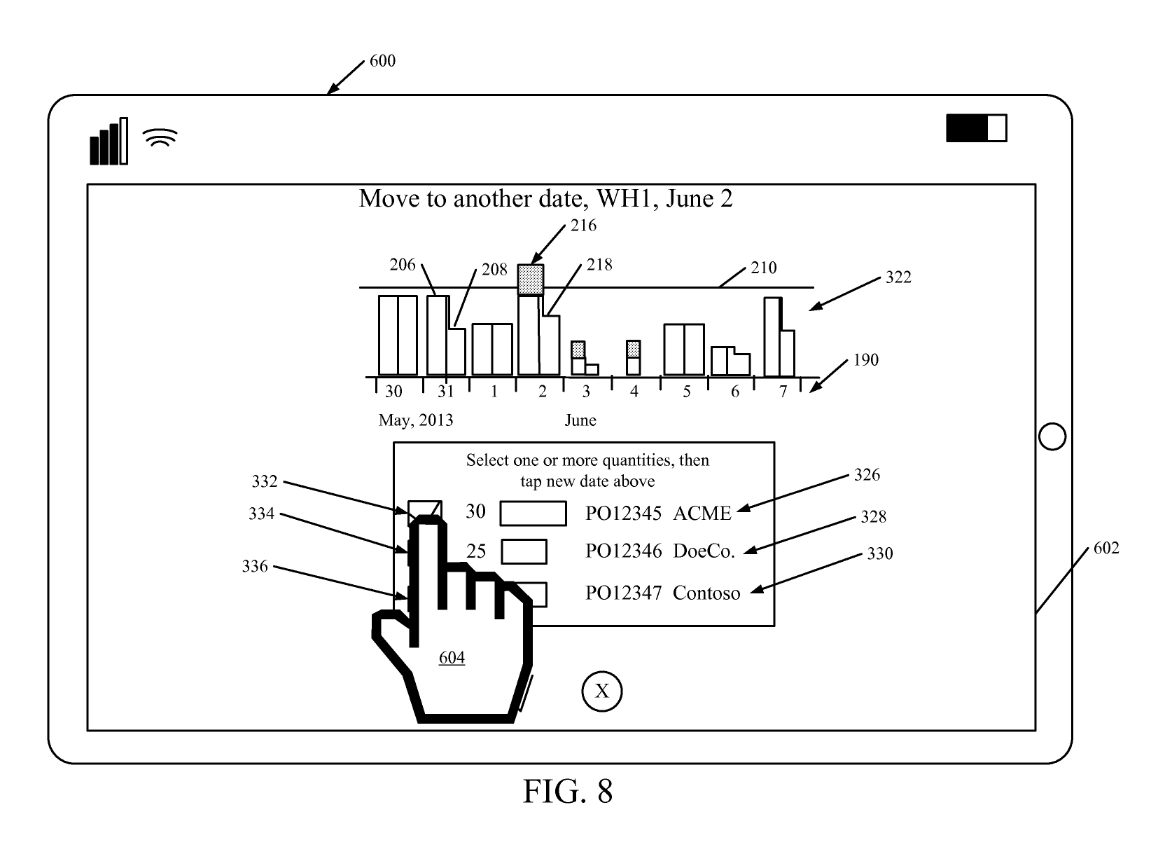

FIG. 7 is a simplified block diagram of one illustrative embodiment of a handheld or mobile computing device that can be used as a user's or client's hand held device 16, in which the present system (or parts of it) can be deployed. FIGS. 8-11 are examples of handheld or mobile devices.

FIG. 7 provides a general block diagram of the components of a client device 16 that can run components of architecture 100 or system 102 or that interacts with architecture 100, or both. In the device 16, a communications link 13 is provided that allows the handheld device to communicate with other computing devices and under some embodiments provides a channel for receiving information automatically, such as by scanning Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1Xrtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like component 138) are received on a removable Secure Digital (SD) card that is connected to a SD card interface 15. SD card interface 15 and communication links 13 communicate with a processor 17 (which can also embody processors 114 or 132 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. Similarly, device 16 can have a client business system 24 which can run various business applications or embody parts or all of business system 102. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 8 shows one embodiment in which device 16 is a tablet computer 600. In FIG. 8, computer 600 is shown with user interface display from FIG. 5C displayed on the display screen 602. Screen 602 can be a touch screen (so touch gestures from a user's finger 604 can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

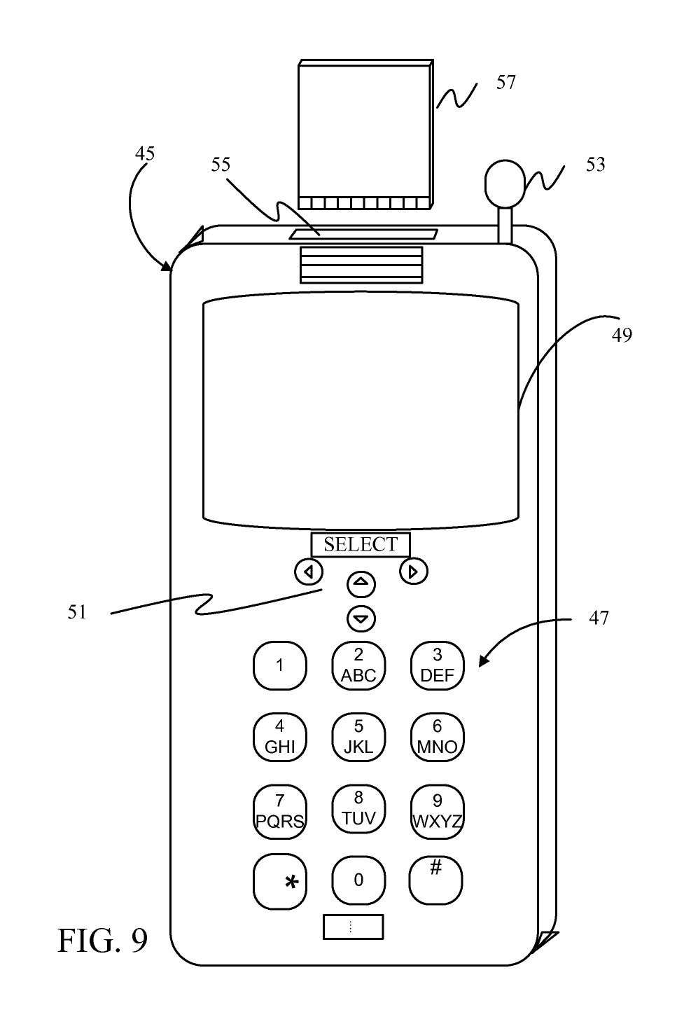

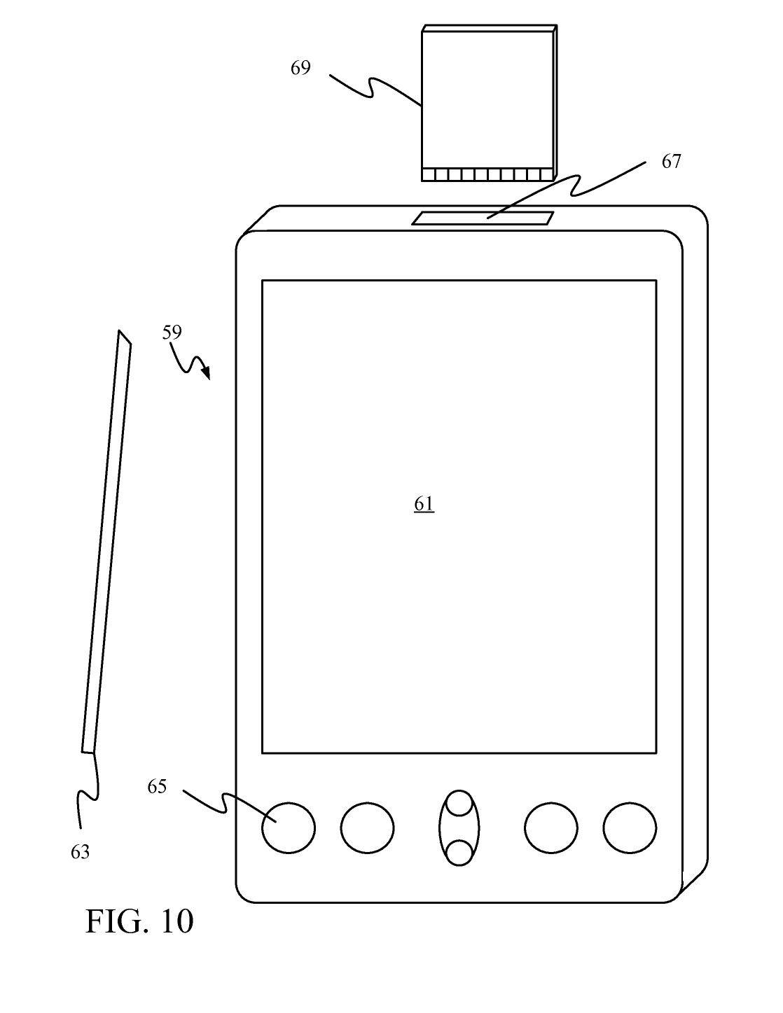

FIGS. 9 and 10 provide additional examples of devices 16 that can be used, although others can be used as well. In FIG. 9, a feature phone, smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1Xrtt, and Short Message Service (SMS) signals. In some embodiments, phone 45 also includes a Secure Digital (SD) card slot 55 that accepts a SD card 57.

The mobile device of FIG. 10 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

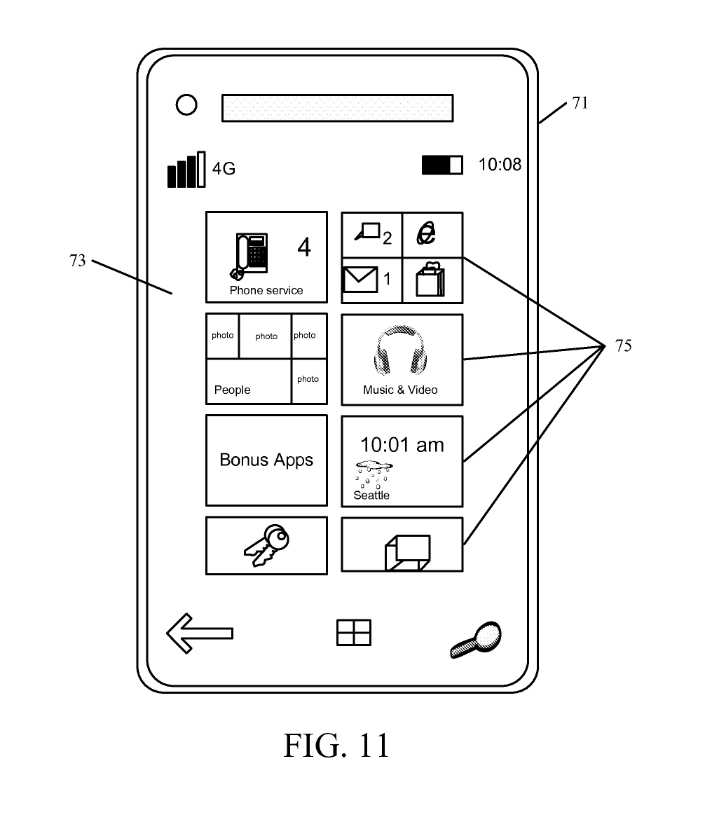

FIG. 11 is similar to FIG. 9 except that the phone is a smart phone 71. Smart phone 71 has a touch sensitive display 73 that displays icons or tiles or other user input mechanisms 75. Mechanisms 75 can be used by a user to run applications, make calls, perform data transfer operations, etc. In general, smart phone 71 is built on a mobile operating system and offers more advanced computing capability and connectivity than a feature phone.

Note that other forms of the devices 16 are possible.

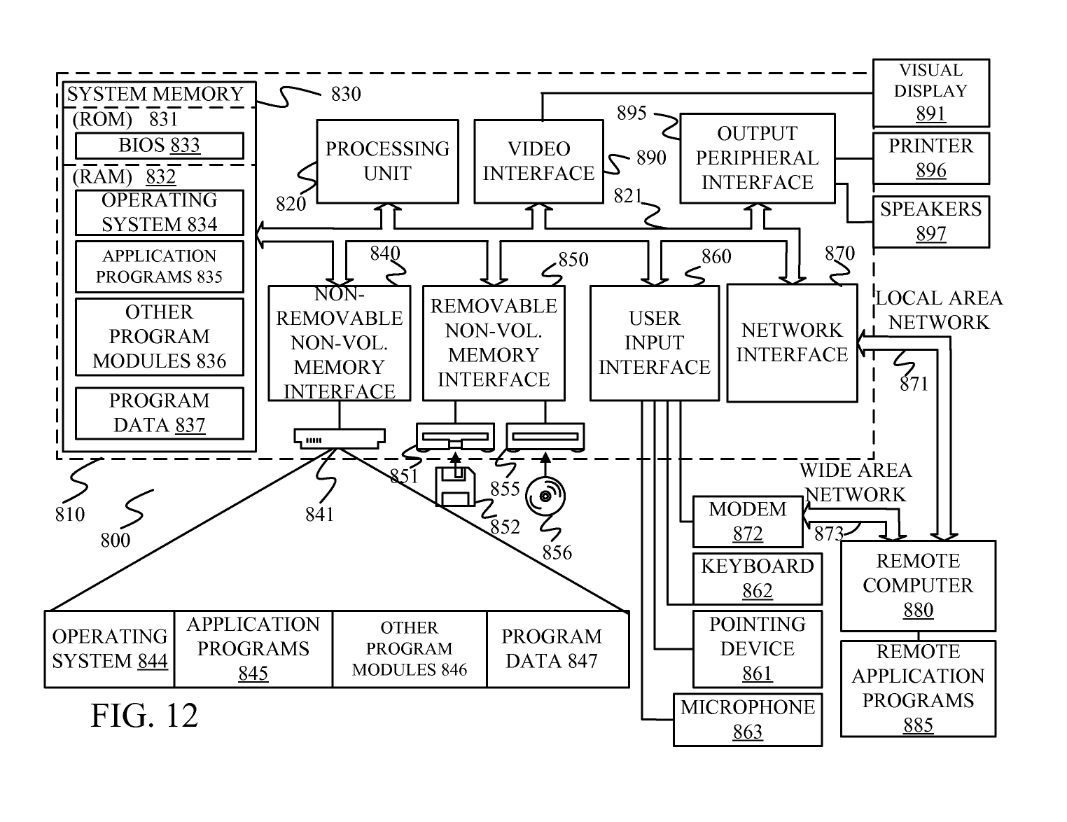

FIG. 12 is one embodiment of a computing environment in which architecture 100, or parts of it, (for example) can be deployed. With reference to FIG. 12, an exemplary system for implementing some embodiments includes a general-purpose computing device in the form of a computer 810. Components of computer 810 may include, but are not limited to, a processing unit 820 (which can comprise processor 114 or 132), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 12.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 12 illustrates operating system 834, application programs 835, other program modules 836, and program data 837.

The computer 810 may also include other removable/non-removable volatile/nonvolatile computer storage media. By way of example only, FIG. 12 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

Alternatively, or in addition, the functionality described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The drives and their associated computer storage media discussed above and illustrated in FIG. 12, provide storage of computer readable instructions, data structures, program modules and other data for the computer 810. In FIG. 12, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 12 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 12 illustrates remote application programs 885 as residing on remote computer 880. It will be appreciated that the network connections shown are exemplary and other means of establishing a communications link between the computers may be used.

It should also be noted that the different embodiments described herein can be combined in different ways. That is, parts of one or more embodiments can be combined with parts of one or more other embodiments. All of this is contemplated herein.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of tracking resource capacity, comprising:
calculating resource capacity for a plurality of individual physical resources;
displaying, on a display screen of a mobile device, a capacity display as an equalized view of the resource capacity for each physical resource plotted against time, the capacity display being a common visual reference on the equalized view, for each physical resource, regardless of variations in the resource capacity for each physical resource over time; and
displaying, on the equalized view, a workload display corresponding to a projected workload for each physical resource, plotted against time, the workload display being physically positioned relative to the capacity display to indicate a volume of the resource capacity for each physical resource relative to a volume of the projected workload for each physical resource, over time.

2. The computer-implemented method of claim 1 wherein displaying a capacity display as an equalized view comprises:
displaying the capacity display as a common visual reference, for each physical resource, regardless of variations in the resource capacity from one physical resource to another.

3. The computer-implemented method of claim 2 wherein displaying the capacity display comprises:
scaling the resource capacity for each physical resource against a common index value so the resource capacity of each physical resource on each of a plurality of displayed days corresponds to a same predetermined number of index units.

4. The computer-implemented method of claim 3 wherein displaying a workload display comprises:
displaying the workload display for each of the displayed days scaled to the common index value so the workload display represents the projected workload for each physical resource, on each of the displayed days, in terms of index units.

5. The computer implemented method of claim 2 wherein displaying the capacity display comprises:
displaying the capacity display for each physical resource as a horizontal line displayed parallel to a date axis.

6. The computer-implemented method of claim 5 wherein displaying the workload display comprises:
displaying the workload display for each physical resource as a vertical display element indicative of the projected workload for each physical resource on each day along the date axis, the vertical element being scaled to a same scale as the horizontal line so displaying the vertical display element to terminate at the horizontal line indicates that the projected workload for the corresponding physical resource on the corresponding day meets the capacity for the corresponding physical resource on the corresponding day.

7. The computer-implemented method of claim 2 wherein displaying the capacity and the workload displays for the plurality of physical resources comprises:
displaying the capacity display and the workload display for the plurality of physical resources along a common, horizontally scrollable, date axis.

8. The computer-implemented method of claim 7 wherein displaying the workload display comprises:
displaying a physical resource label, that identifies each corresponding physical resource, over the workload display for the corresponding physical resource; and
displaying a data freshness indicator indicating a freshness of displayed data.

9. The computer-implemented method of claim 7 wherein displaying the workload display, comprises
displaying the workload display for each physical resource in a vertically scrollable list of physical resources.

10. The computer-implemented method of claim 7 wherein displaying the workload display, comprises:
automatically scrolling the workload display along the date axis to display the workload display and the capacity display for the physical resources on a first day when a workload for a given physical resource exceeds a capacity for the given physical resource.

11. The computer-implemented method of claim 7 wherein displaying the workload display comprises:
automatically sorting the workload displays for the plurality of physical resources, based on an urgency metric, to identify selected physical resources with workload problems; and
automatically displaying the selected physical resources in order based on the urgency metric.

12. The computer-implemented method of claim 6 wherein displaying the workload display comprises:
displaying an excess display portion of a projected workload for a given physical resource, that exceeds a capacity for the given physical resource, in visual contrast to a remaining portion of the projected workload for the given resource.

13. The computer-implemented method of claim 12 and further comprising:
receiving a user selection input selecting the excess display portion; and
automatically displaying suggestions for handling workload corresponding to the excess display portion, the suggestions including moving the workload corresponding to the excess display portion to another physical resource, and moving the workload corresponding to the excess display portion to another date.

14. The computer-implemented method of claim 13 and further comprising:
receiving a suggestion user input selecting a displayed suggestion; and
displaying, on the equalized view, at least one option indicating a different physical resource or available date to which the workload corresponding to the excess display portion can be moved.

15. The computer-implemented method of claim 14 and further comprising:
receiving a user input indicative of a selected option; and
displaying a workload display and capacity display on the equalized view for the plurality of physical resources simulating the selected option.

16. The computer-implemented method of claim 15 wherein receiving the user selection input selecting the excess display portion comprises:
after receiving a user selection input, displaying a transaction breakdown display that shows selectable transactions that make up the workload corresponding to the excess display portion; and
receiving user selection of a selectable transaction.

17. A mobile device, comprising:
a display device;
a client resource management component that displays a horizontally scrollable list of workload/capacity displays on the display device, each workload/capacity display showing a projected workload and capacity for a corresponding physical resource, plotted against a common time axis that is common to all workload/capacity displays, the capacity for each physical resource being represented by a horizontal line, regardless of variations in capacity over time, and each projected workload being scaled relative to the horizontal line to indicate a volume of workload relative to a volume of capacity, for each physical resource on each day along the common time axis; and
a computer processor that is a functional part of the mobile device and activated by the client resource management component to facilitate displaying the workload/capacity displays, and wherein the physical resources comprise warehouses and wherein the workload/capacity displays each include an inbound workload display bar indicative of a volume of workload projected for an inbound dock at a given warehouse and an outbound display bar indicative of a volume of workload on an outbound dock at the given warehouse, and further indicating with a visually contrasting display portion, a part of the workload indicated by the inbound display bar or the outbound display bar that exceeds the capacity indicated by the horizontal line.

19. The mobile device of claim 17 wherein the client resource management component displays an off-screen indicator which, when actuated by a user, navigates the user to a part of the workload/capacity displays where the projected workload for a given physical resource exceeds the capacity for the given physical resource.

19. The mobile device of claim 18 wherein the client resource management component receives a user selection input selecting the visually contrasting portion, visually displays suggested options for moving a workload corresponding to the visually contrasting display portion to another day or to another warehouse, receives a user input selecting one of the displayed suggestions and displays the workload/capacity displays modified to simulate moving the workload corresponding to the visually contrasting display portion as indicated by the selected suggestion.

20. A computer readable storage medium storing computer executable instructions which, when executed by a computer, cause the computer to perform a method comprising:
displaying a horizontally scrollable list of workload/capacity displays on the display device, each workload/capacity display showing a projected workload and capacity for a corresponding warehouse, plotted against a common time axis that is common to all workload/capacity displays, the capacity for each warehouse being represented by a horizontal line, regardless of variations in capacity over time, and each projected workload being a vertical display element scaled relative to the horizontal line to indicate a volume of workload relative to a volume of capacity, for each warehouse on each day along the common time axis, each workload/capacity display indicating, with a visually contrasting display portion of the vertical display element, a part of the projected workload indicated by the vertical display element that exceeds the capacity indicated by the horizontal line;
receiving a user selection input selecting the visually contrasting portion;
visually displaying suggested options for moving a workload corresponding to the visually contrasting display portion to another day or to another warehouse;
receiving a user input selecting one of the displayed suggestions; and
displaying the workload/capacity displays modified to simulate moving the workload corresponding to the visually contrasting display portion as indicated by the selected suggestion.
